(19) United States
(12) Patent Application Publication
(10) Pub. No.: US 2009/0285443 A1
(43) Pub. Date: Nov. 19, 2009

(54) Remote Control Based on Image Recognition

(75) Inventors: William O. Camp, JR., Chapel Hill, NC (US); Leland Scott Bloebaum, Cary, NC (US); David Michael McMahan, Raleigh, NC (US)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 12/120,687

(22) Filed: May 15, 2008

(51) Int. Cl. G06K 9/00

(52) U.S. Cl. 382/100

(57) ABSTRACT

A remote control device uses image recognition to recognize features or objects in an on-screen menu displayed on an external display associated with a controlled device. The on-screen menu may contain one or more control objects for controlling the associated appliance. A camera in the remote control device captures at least a portion of the menu displayed on the external display. A controller including an image processor generates control signal based on recognition of one or more control objects in the displayed image. A transmitter connected to the controller transmits the control signal to the controlled appliance.

### BACKGROUND

The present invention relates generally to remote control methods and devices and, more particularly, to methods and devices for remotely controlling an appliance using image recognition.

Remote control devices are used to control many types of consumer electronic devices or consumer appliances. For example, remote control devices are frequently used to control a home theater system, home stereo system, cable/satellite television system, and digital video recorders/players. Typically, the controlled device outputs a menu to a display, such as a television. The remote control device is used to navigate the on-screen menu and to make selections.

A common problem with remote control devices is that consumers typically have many different remote control devices for different systems. For example, a user may have one remote control device to control a television set, another remote control device to control a cable or satellite box, a third remote control device to control a digital video recorder/player, and a fourth remote control device to control a stereo system.

Universal remote controls that can be programmed to control multiple devices are known. However, these universal remote control devices must be programmed by the consumer to operate with the consumer's equipment. Programming a universal remote control can be a tedious and time-consuming project, and can be confusing to many users.

It is also known to use a cellular phone or personal digital assistant to remotely control consumer electronic devices or other appliances. A cellular phone or PDA may be equipped with a short-range interface (e.g., infrared or radio frequency) for communicating with consumer electronic devices. Cell phones and PDAs with remote control capabilities suffer from the same difficulties found in conventional universal remote controls.

Therefore, there is a need for new methods for remotely controlling consumer electronic devices and other appliances that is easy for consumers to use, and that easily incorporates into wireless communication devices, such as cell phones and personal digital assistants.

### SUMMARY

The present invention relates to remote control of consumer electronic devices and other appliances using image recognition. More specifically, the present invention uses image recognition to recognize features or objects in an on-screen menu displayed on an external display associated with a controlled device. The on-screen menu may contain one or more control objects for controlling the associated appliance. A camera in the remote control device captures at least a portion of the menu displayed on the external display. A controller including an image processor generates control signal based on recognition of one or more control objects in the displayed image. A transmitter connected to the controller transmits the control signal to the controlled appliance.

Exemplary embodiments of the invention further comprise a remote control device for remotely controlling an appliance. According to one embodiment, the remote control device comprises a camera for capturing at least a portion of an menu displayed on a display, said displayed menu containing one or more on-screen control objects for a controlled appliance; a controller including an image processor to generate control signal based on recognition of one or more on-screen control objects in said displayed menu; and a transmitter connected to said controller to transmit said control signal to control the appliance.

In some embodiments, the remote control device may further comprise a user input device to receive user input indicating selection by the user of an on-screen control object.

In some embodiments, the control signal generated by said controller includes an identification of an on-screen control object selected by a user.

In some embodiments, the control signal generated by said controller includes control signals associated with a control object selected by a user.

In some embodiments, the control signal generated by said controller includes an identification of an on-screen control object recognized by said image processor.

In some embodiments, the remote control device further comprises a second display to display a captured image comprising at least a portion of the displayed menu to a user.

In some embodiments, the displayed menu includes a menu key to identify the on-screen control objects and the image processor in the remote control device decodes the menu key to determine the on-screen control objects to be recognized.

In some embodiments, the remote control device further comprises a receiver to receive a list of on-screen control objects to be recognized.

Exemplary embodiments of the invention may also comprise a method for remotely controlling an appliance. In one exemplary embodiment, a method for remotely controlling an appliance comprises capturing at least a portion of a menu displayed on a display, said displayed menu containing one or more on-screen control objects for a controlled appliance; generating control signal based on recognition of one or more on-screen control objects in said displayed menu; and transmitting said control signal to control the appliance.

In some embodiments, capturing at least a portion of a menu displayed on a display is responsive to a user input indicating selection of an on-screen control object.

In some embodiments, generating a control signal based on recognition of one or more on-screen control objects in said displayed menu comprises processing a selected portion of said menu captured responsive to said user input to identify the on-screen control object selected by the user, and generating control signal identifying the user-selected on-screen control object selected by the user.

In some embodiments, generating a control signal based on recognition of one or more on-screen control objects in said displayed menu comprises processing a selected portion of said menu captured responsive to said user input to identify the on-screen control object selected by the user, and generating a control signal associated with the control object selected by the user.

In some embodiments, generating a control signal based on recognition of one or more on-screen control objects in said displayed menu comprises processing a selected portion of said menu to identify an on-screen object; and generating control signal identifying the on-screen control object recognized by said image processor.

In some embodiments, the method further comprises receiving user input indicative of a user selection of an on-screen control object; and transmitting an indication of a user selection responsive to said user input.

In some embodiments, the method further comprises outputting a captured portion of said displayed menu to a user on a second display on a remote control device.

In some embodiments, the displayed menu includes a menu key to identify the on-screen control objects and the method further comprises decoding the menu key to determine on-screen control objects to be recognized.

In some embodiments, the method further comprises receiving information from a remote device identifying said on-screen control objects.

Exemplary embodiments of the invention may also comprise an input device for generating position feedback for a graphical user interface. An exemplary input device comprises a camera for capturing at least a portion of graphical user interface displayed on a display, said graphical user interface containing one or more reference objects; and a controller including an image processor to generate position feedback based on recognition of one or more reference objects in said graphical user interface.

In some embodiments, the position feedback comprises a computed position of a selected point in a captured image relative position of the selected point to one or more reference objects.

In some embodiments, the graphical user interface may comprise an on screen menu for a controlled appliance and the input device may be used as a remote control device to navigate the on-screen menu.

Exemplary embodiments of the invention may also comprise a method for generating position feedback for a graphical user interface. An exemplary method for generating position feedback for a graphical user interface comprises capturing at least a portion of an menu displayed on a display, said displayed menu containing one or more reference objects; and generating position feedback based on recognition of one or more reference objects in said graphical user interface.

In some exemplary embodiments, generating position feedback based on recognition of one or more reference objects in said displayed menu comprises computing a position of a selected point in said captured image based on the relative position of the selected point to one or more reference objects.

In some embodiments, the graphical user interface may comprise an on-screen menu for a controlled appliance and the exemplary methods may be implemented by a remote control device to navigate an on-screen menu and make selections.

Exemplary embodiments of the invention may also comprise in input device including an accelerometer for navigating an on-screen menu. An exemplary input device comprises an accelerometer for detecting sudden movement of said input device, and a processor to determine a direction of movement and to generate control signals based on the direction of movement.

In some embodiments of the input device, the control signal generated by the processor may include or comprise an indication of the direction of movement.

In some embodiments of the input device, the control signal generated by the processor may include or comprise a command associated with a direction of movement.

Exemplary embodiments of the invention may also comprise a method for generating position feedback using an accelerometer. An exemplary method for navigating an on-screen menu comprises detecting movement of the input device using an accelerometer, determining the direction of the movement, and generating a control signal based on the direction of movement.

In some embodiments of the method, the control signal generated by the processor may include or comprise an indication of the direction of movement.

In some embodiments of method, the control signal generated by the processor may include or comprise a command associated with a direction of movement.

### BRIEF DESCRIPTION OF THE DRAWINGS

FIG. 1 illustrates an arrangement for remotely controlling a consumer electronic device or other appliance using image recognition.

FIG. 2 is a block diagram of an exemplary remote control device using image recognition.

FIG. 3 illustrates a remote control device embodied in a cellular phone.

FIG. 4 illustrates an exemplary on-screen menu with one or more selectable control objects.

FIG. 5 illustrates an exemplary procedure for selecting objects in said on-screen menu or graphical user interface.

FIG. 6 illustrates an exemplary on-screen menu with a control object highlighted to show where the current focus is.

FIG. 7 illustrates an exemplary procedure for navigating on-screen menu or graphical user interface.

FIG. 8 illustrates an exemplary on-screen menu with one or more reference objects for navigation.

FIG. 9 illustrates an exemplary procedure for navigating on-screen menu or graphical user interface.

FIG. 10 illustrates an exemplary method of navigating an on-screen menu using an accelerometer.

### DETAILED DESCRIPTION

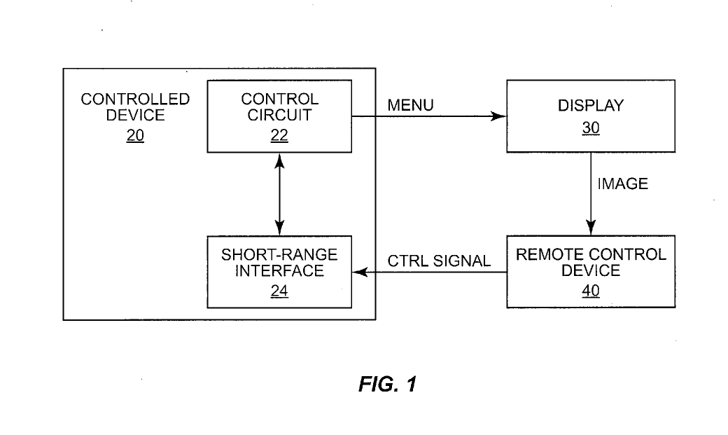

Referring now to the drawings, FIG. 1 illustrates an arrangement for controlling a consumer electronic device or appliance, i.e., the controlled device 20, according to one embodiment of the present invention. The controlled device 20 may comprise, for example, television, cable/satellite box, a digital video recorder/player, digital audio recorder/player, camera, computer, or home appliance. The controlled device 20 includes a control circuit 22 to control the operation of the controlled device 20 and a short-range interface 24, such as an infrared interface or short-range radio interface (e.g., BLUETOOTH interface) to communicate with a remote control device 40. Typically, the control circuit 22 comprises a microprocessor, microcontroller, hardware circuit, or combination thereof, and a memory for storing an operating system program. The operating system program preferably provides a menu system or graphical user interface that is displayed to a user on a display 30 associated with the controlled device 20. Those skilled in the art will appreciate that the display 30 may be part of the controlled device 20 or may be a separate device. The graphical user interface or menu 32 displayed to the user may comprise one or more selectable objects that enable the user to select options and control the controlled device 20.

A remote control device 40 in communication with the control circuit 22 enables the user to navigate the menu system and to select the on-screen control objects using image recognition. The remote control device 40 captures images of the displayed menu 32 and uses image recognition to enable the user to navigate the menu 32 and make selections. The remote control device 40 generates control signals based on recognized objects and transmits the control signals to the control circuit 22 of the controlled device 20 via a short-range interface, such as an infrared interface or short-range radio interface.

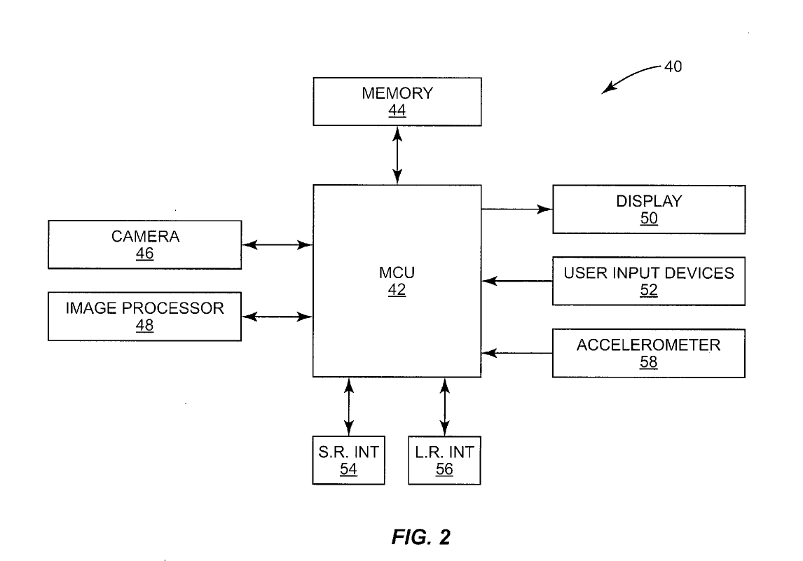

FIG. 2 illustrates an exemplary remote control device 40 according to one embodiment of the invention. The remote control device 40 comprises a main control unit (MCU) 42, memory 44, camera 46, image processor 48, display 50, one or more user input devices 52, a short-range interface 54, and a long-range interface 56. Some embodiments may further include an accelerometer 58. The main control unit 42 comprises one or more processors or microcontrollers to control overall operation of the remote control device 40 according to instructions stored in memory 44. The memory 44 stores instructions and data needed for operation. Memory 44 may comprise a random access memory, read-only memory, Flash memory, or a combination thereof. Camera 46 captures a selected portion of the menu 32 displayed to the user on the display 30. Image processor 48 processes the images captured by the camera 46 as will be hereinafter described to recognize selectable control objects in the displayed menu 32. Display 50 functions as a viewfinder to allow the user to see the image captured by the camera 46. As will become apparent from the following description, some embodiments of the invention may omit the display 50. The user input devices 52 comprise keypads, buttons, or the like to enable the user to indicate a selection of an on-screen control as hereinafter described. The short-range interface 54, such as an infrared interface or short-range radio interface (e.g. BLUETOOTH, WIFI, etc), enables communication with the control circuit 22 in the controlled device 20. A long-range interface 56, such as a cellular transceiver, may also be provided in some embodiments.

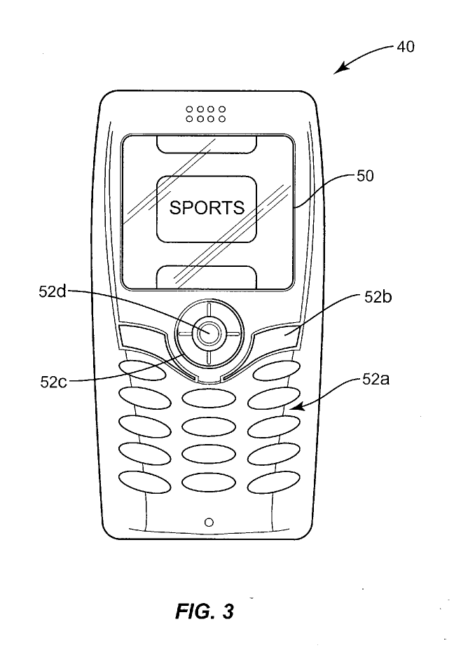

The remote control device 40 may be a dedicated device that functions exclusively as a remote control, or may have additional functionally. Virtually any type of device with a camera can function as a remote control device 40. For example, many cellular phones and personal digital assistants (PDAs) are equipped with a camera. Such devices can be used as a remote control device 40. FIG. 3 is a front elevation view of a cellular phone with remote control capabilities that functions as a remote control device 40. The cellular phone includes a built-in camera 46 (FIG. 1) and a display 50 for displaying images captured by the camera 46. The cellular phone also includes a keypad 52a, soft keys 52b, multi-directional navigation control 52c, and a selection button 52d that function as user input devices 52.

In use, the camera 46 in the remote control device 40 is used to capture all or a selected portion of the on-screen menu displayed to the user on the external display 30. The image processor 48 processes selected portions of the displayed menu 32 captured by the camera 46. More particularly, the image processor 48 implements image recognition algorithms to recognize features or objects in the displayed menu 32, such as selectable control objects, reference marks, etc. The recognized features or objects may then be used to generate control signal for controlling the controlled device 20. The control signal may be used to navigate between on-screen control objects in the displayed menu 32, or to indicate selection of an on-screen control object. In other embodiments, the image processor 48 may use recognized features of the display to generate position information for navigating the on-screen menu 32 or moving an on-screen cursor.

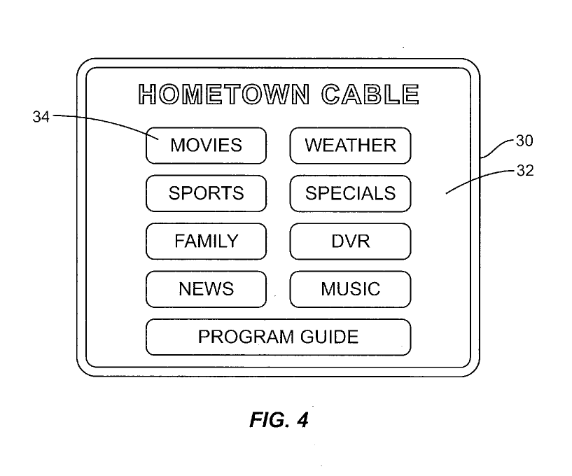

FIG. 4 illustrates an exemplary on-screen menu 32 for a digital cable system. The menu 32 comprises a plurality of on-screen control objects 34 in the form of virtual buttons. Those skilled in the art will appreciate that the menu 32 may include additional control objects, such as scroll bars, menu bars, tool bars, etc. The displayed menu 32 may further include company logos, advertisements, and other items not directly related to control of the appliance. The on-screen control objects 34 may in some embodiments have visually-distinctive features that enable the on-screen control objects 34 to be distinguished from one another. For example, the on-screen control objects 34 may be of different colors, different shapes, or different textures. The on-screen control objects 34 may include barcodes or symbols that enable the image processor 48 to recognize different control objects 34. The on-screen control objects 34 could also be distinguished by text labels that can be recognized by the image processor 48 using optical character recognition.

In one exemplary embodiment, the user of the remote control device 40 positions the remote control device 40 such that the selected control object 34 appears in the display 50 of the remote control device 40 as shown in FIG. 3. When the desired on-screen control object 34 appears in the display 50 of the remote control device 40, the user may press a designated SELECT button to select the control object 34 appearing in the viewfinder. The display 50 may include a visual aid such as a cross-hair or selection box to help the user in the selection of a desired control object 34. When the SELECT button is pressed, the image appearing in the display 50 is captured by the camera 46 and passed to the image processor 48. The image processor 48 processes the captured image to identify the control object 34 selected by the user and outputs an identification of the control object 34 to the MCU 42. The identification of the control object 34 may be sent to the control circuit 22 in the controlled device 20 as control signal. The control circuit 22 may then invoke an action associated with the selected control object 34.

In some embodiments of the invention, the remote control device 40 may store a table in memory 44 associating the selectable control objects 34 displayed in the menu 32 with specific control commands or signals. The MCU 42 may use the identifying information provided by the image processor 48 to look up an associated control command or control signal stored in memory 44. The control command or control signal matching a recognized object can then be transmitted to the control circuit 22 in the controlled device 20.

In some embodiments of the invention, the image processor 48 may require a priori knowledge of the features or objects to be extracted from the captured image of the displayed menu 32. The menu 32 displayed on the display 30 may include a key in a predetermined location. The key functions like a map key, with the features to be recognized identified in the key. The image processor 48 can then recognize control objects 34 by matching the control objects 34 in the image to corresponding key elements. Alternatively, a list of features or objects to be recognized by the remote control device 40 may be sent to the remote control device 40 via the short-range interface 54. For example, if BLUETOOTH technology is employed, the control circuit 22 may discover the remote control device 40 when the remote control device 40 is within range and send the remote control device 40 a list of features or objects to be recognized. In some embodiments, the remote control device 40 may discover the controlled device 20 and request the feature list from the control circuit 22. Thus, the remote control device 40 can be configured to operate with a controlled device 20 without programming or user intervention.

Not all embodiments of the invention will require a priori knowledge of the control objects 34. For example, the control objects 34 may include text labels that can be recognized using optical character recognition. In this case, the image processor 48 processes the captured image to extract the alphanumeric characters or text. The alphanumeric characters or text can then be transmitted to the control circuit as a control signal. Alternatively, the MCU 42 may use the alphanumeric or text screens to look up corresponding control commands or signals stored in memory 44.

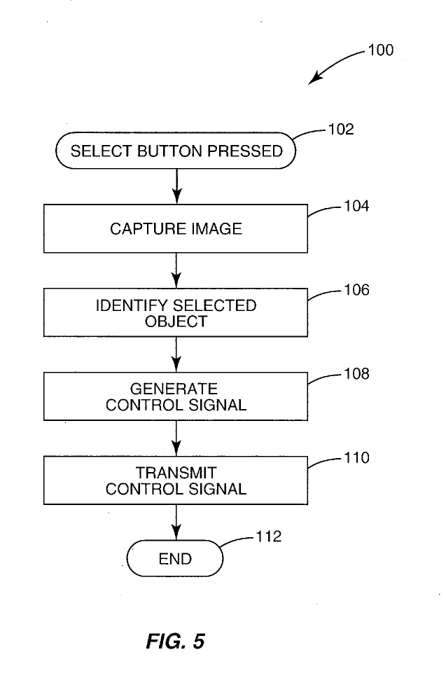

FIG. 5 illustrates an exemplary procedure 100 for generating control commands responsive to user selection of a control object according to one exemplary embodiment. The procedure 100 begins when the user frames a selected control object in the display 50 of the remote control device 40 and presses a designated SELECT button on the remote control device 40 (block 102). When the SELECT button is pressed, the camera 46 in the remote control device 40 captures the image currently displayed in the display of the remote control device 40 (block 104). The image processor 48 in the remote control device 40 processes the captured image to identify the selected object (block 106). For example, the image processor 48 may extract objects from the captured image and compare the extracted objects to the key to identify the selected object. Information identifying the selected object is then passed to the MCU 42. In some embodiments, the image processor 48 may use optical character recognition to recognize text labels associated with the control objects 34 and provide the recognized text to the MCU 42. The MCU 42 uses the information provided by the image processor 48 to generate a control signal (block 108). The control signal may be as simple as an identification of the selected object. The identification may comprise the recognized text if text recognition is used. Alternatively, the MCU 42, may use the identification of the selected object to lookup a corresponding control signal in a lookup table stored in memory 44. The MCU 42 then sends the generated control signal to the control circuit 22 (block 110) and the procedure ends (block 112).

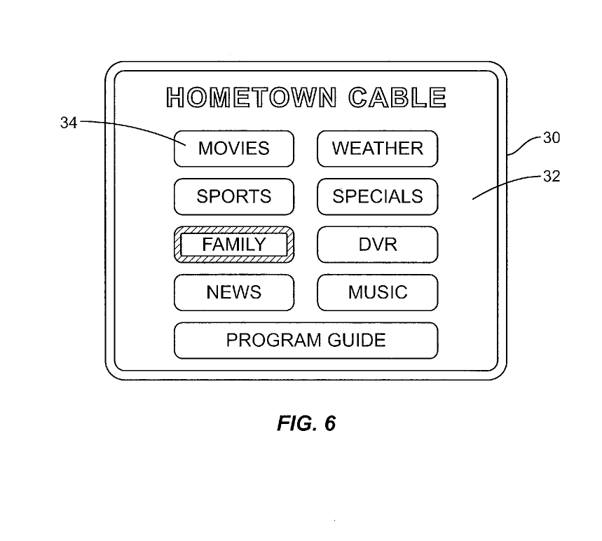

In a second exemplary embodiment, the image recognition system in the remote control device 40 may be used to navigate the on-screen menu 32. The on-screen menu 32 may indicate a control object 34 having the current focus by highlighting the control object as shown in FIG. 6. In conventional remote control devices 40, navigation keys are used to move the current focus from one object to another. When a SELECT button is pressed, the object with the current focus is selected. In a similar manner, the image recognition system can be used to move the focus on the on-screen menu 32 from one control object 34 to another. In this embodiment, the control object 34 in the on-screen menu 32 with the current focus may be shown by highlighting or some other visual indication. In this embodiment, the control circuit 22 moves the focus on the on-screen menu 32 to the control object 34 that is recognized by the image recognition system.

The remote control device 40 may have a search mode in which the image recognition continuously searches for control objects 34 and indicates when a selectable control object 34 is recognized. The remote control device 40 may be placed in a search mode by pressing a designated key, or may default to the search mode when the remote control device 40 is turned on or activated. When in the search mode, the camera 46 in the remote control device 40 captures images at a predetermined rate (e.g., five times per second) and the image processor 48 evaluates each captured image to extract recognized features or objects. When a selectable feature or object is recognized, a signal is sent by the image processor 48 to the MCU 42 that identifies the recognized object. The MCU 42 may transmit the identification of the recognized object to the control circuit 22 in the controlled device 20, which causes the focus to move on the on-screen menu 32 to the recognized object. To make a selection, the user can press a predetermined SELECT button on the remote control device 40. When the SELECT button is pressed, a control signal is sent to the control circuit 22 in the controlled device 20 indicating that the control object 34 with the current focus has been selected by the user. The control circuit 22 then performs the action associated with the control object 34 selected by the user.

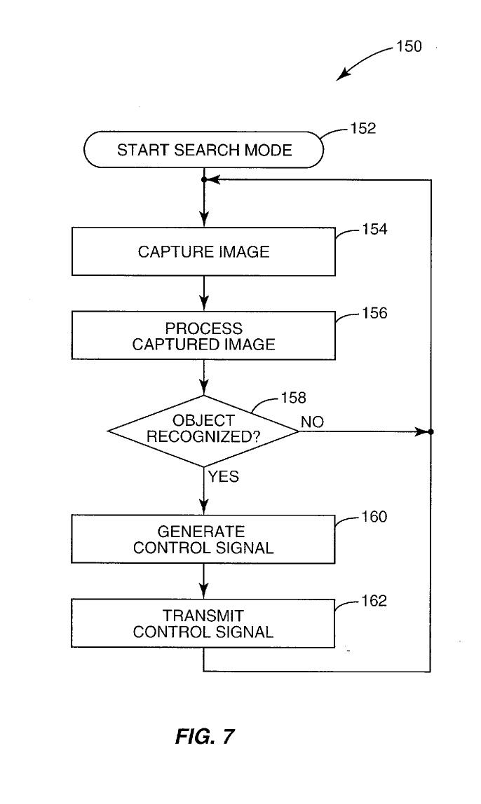

FIG. 7 illustrates an exemplary procedure for navigating an on-screen menu 32 as described above. The procedure begins when the remote control device 40 is placed in a search mode (block 152). While in search mode, the camera 46 in the remote control device 40 captures images at a predetermined rate (block 154). Each time an image is captured, the image processor 48 processes the captured image to identify any recognized control objects 34 (block 156). If a control object 34 is recognized (block 158), the image processor 48 notifies the MCU 42. The MCU 42 generates a control signal identifying the selected object (block 160) and transmits the control signal to the control circuit 22 (block 162). The control circuit 22 moves the focus on the on-screen menu 32 to the identified control object 34. Alternatively, the MCU 42 may generate navigation signals (e.g., UP, DOWN, RIGHT, LEFT, etc.) and transmit the navigation signals to the control circuit 22. In this case, the control circuit 22 moves the focus as indicated by the navigation signal. This process repeats at a predetermined time interval.

While in search mode, the user may press a designated SELECT button to select a control object 34 with the current focus as previously described. When the SELECT button is pressed, the MCU 42 may generate a SELECT signal and transmit the SELECT signal to the control circuit 22 to indicate that the user has selected the control object 34 with the current focus.

In some embodiments of the invention, one or more reference marks on a displayed menu 32 may be used to generate position information that is transmitted to the control circuit 22 in the controlled device 20. The position information can be used to move a cursor on the on-screen menu 32 in a manner similar to a mouse or touchpad, or can be used to indicate selection of a control object 34 at the indicated position.

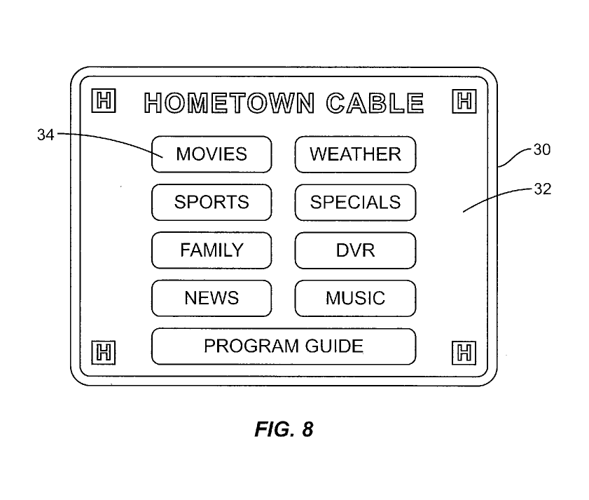

FIG. 8 illustrates an exemplary menu having reference marks in each of the four corners of the menu 32. The camera 46 is aimed at the external menu 32 on the display 30 and images of the displayed menu 32 are captured at a predetermined rate (e.g., 10/sec.). The image capture rate may be varied, depending on the needs of a particular application. As the remote control device 40 is moved by the user, the center point of the captured image relative to the four reference marks changes. The position of the center point of the captured image relative to the four reference marks can be computed and sent to the control circuit 22 as control signal. The control circuit 22 can use the position information to move the focus on the on-screen menu 32 or to move an on-screen cursor. When the current focus is on a desired control object, the user can indicate a selection by pressing a predetermined SELECT button on the remote control device 40. The remote control device 40 then sends a control signal to the control circuit 22 to effectuate selection of the object.

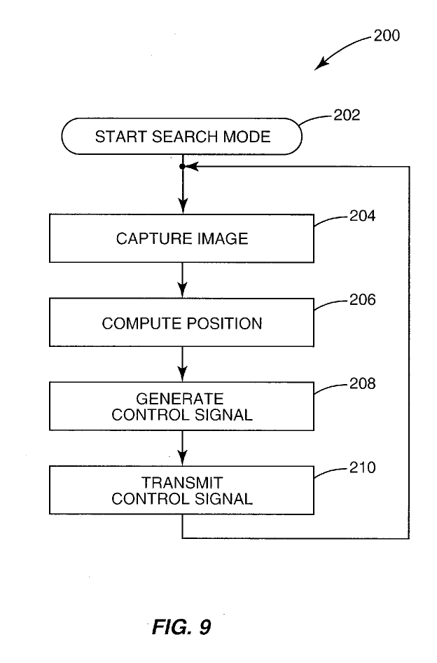

FIG. 9 illustrates an exemplary procedure for navigating an on-screen menu 32 using reference marks to compute position information. The procedure begins when the remote control device 40 is placed in a search mode (block 202). While in search mode, the camera 46 in the remote control device 40 captures images at a predetermined rate (block 204). Each time an image is captured, the image processor 48 processes the captured image to compute the position of the center point of the captured image relative to the four reference marks (block 206). The MCU 42 generates a control signal including the calculated position of the center point (block 208) and transmits the control signal to the control circuit 22 (block 210). The control circuit 22 can use the position information to move the focus on the on-screen menu 32 or to move an on-screen cursor.

While in search mode, the user may press a designated SELECT button to select a control object with the current focus or at the current cursor position as previously described. When the SELECT button is pressed, the MCU 42 may generate a SELECT signal and transmit the select signal to the control circuit 22 to indicate that the user has selected the control object 34 with the current focus or at the current cursor position.

The use of image recognition to navigate an on-screen menu 32 and to make selections may be used in combination with other techniques. For example, the remote control device 40 may include an accelerometer 58 (FIG. 2) for detecting sudden movement of the remote control device 40. When a sudden movement is detected, the MCU 42 may determine the direction of the movement. The direction information can be sent to the control circuit 22 to move the focus on the on-screen menu 32. Alternatively, the MCU 42 could convert the direction information into control signals (e.g., UP, DOWN, LEFT, RIGHT, etc), which can then be sent to the control circuit 22. Selection of a control object can be made by detecting a button press as previously described. Sudden movement detected by the accelerometer may also be used to indicate selection.

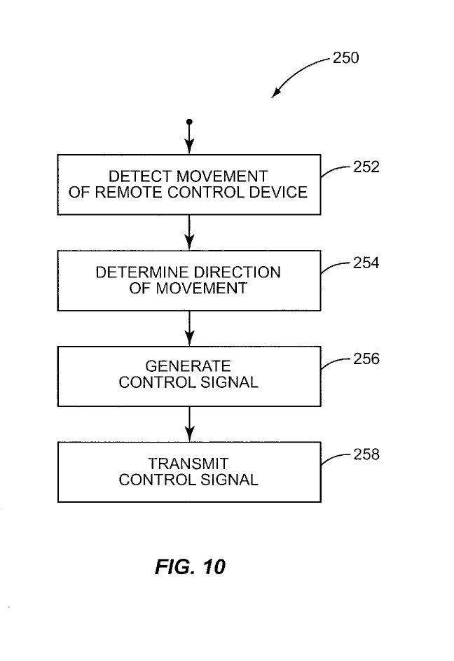

FIG. 10 illustrates an exemplary method 250 of navigating an on-screen menu using an accelerometer. The method comprises detecting a sudden movement of the input device (block 252), determining the direction of movement of the input device (block 254), and generating a control signal based on the direction of movement of the input device (block 256). The control signal may include an indication of the direction of movement. Alternatively, the direction of movement can be mapped to predetermined control signals stored in memory. The control signal is then transmitted to the control circuit 22 (block 258).

Remote control based on image recognition allows virtually any type of device equipped with a camera to function as a remote control device 40. For example, cellular phone or PDA equipped with a digital camera may have a remote control program be preloaded into memory of the mobile phone or PDA by the manufacturer or service provider. Alternatively, a user could download a remote control program from a website over the Internet.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A remote control device for remotely controlling an appliance, said device comprising:
a camera for capturing at least a portion of a menu displayed on a display, said displayed menu containing one or more on-screen control objects for a controlled appliance;
a controller including an image processor to generate a control signal based on recognition of one or more on-screen control objects in said displayed menu; and
a transmitter connected to said controller to transmit said control signal to control the appliance.

2. The remote control device of claim 1 further comprising a user input device to receive user input indicating selection by the user of an on-screen control object, and wherein said control signal generated by said controller includes an identification of the on-screen control object selected by the user.

3. The remote control device of claim 1 further comprising a user input device to receive user input indicating selection by the user of an on-screen control object, and wherein said control signal generated by said controller further comprises a control signal associated with the selected control object.

4. The remote control device of claim 1 wherein said control signal generated by said controller includes an identification of an on-screen control object recognized by said image processor.

5. The remote control device of claim 4 further comprising a user input device to receive user input indicating selection by the user of an on-screen control object, wherein said controller is configured to transmit an indication that the user has made a selection responsive to said user input.

6. The remote control device of claim 1 further comprising a second display to display a captured image comprising at least a portion of the displayed menu to a user.

7. The remote control device of claim 1 wherein said displayed menu includes a menu key to identify the on-screen control objects and wherein said image processor determines the on-screen control objects to be recognized based on the menu key.

8. The remote control device of claim 1 further comprising a receiver to receive a list of on-screen control objects to be recognized.

9. A method for remotely controlling an appliance comprising:
capturing at least a portion of an menu displayed on a display, said displayed menu containing one or more on-screen control objects for a controlled appliance;
generating a control signal based on recognition of one or more on-screen control objects in said displayed menu; and
transmitting said control signal to control the appliance.

10. The method of claim 9 wherein capturing at least a portion of a menu displayed on a display is responsive to a user input indicating selection of an on-screen control object, and wherein generating control signal based on recognition of one or more on-screen control objects in said displayed menu comprises:
processing a selected portion of said menu captured responsive to said user input to identify the on-screen control object selected by the user; and
generating control signal identifying the user-selected on-screen control object.

11. The method of claim 9 wherein capturing at least a portion of a menu displayed on a display is responsive to a user input indicating selection of an on-screen control object, and wherein generating control signal based on recognition of one or more on-screen control objects in said displayed menu comprises:
processing a selected portion of said menu captured responsive to said user input to identify the on-screen control object selected by the user; and
generating a control signal associated with the control object selected by the user.

12. The method of claim 9 wherein generating control signal based on recognition of one or more on-screen control objects in said displayed menu comprises:
processing a selected portion of said menu to identify an on-screen object; and
generating control signal identifying the on-screen control object recognized by said image processor.

13. The method of claim 12 further comprising:
receiving user input indicative of a user selection of an on-screen control object; and
transmitting an indication of a user selection responsive to said user input.

14. The method of claim 9 further comprising outputting a captured portion of said displayed menu to a user on a second display on a remote control device.

15. The method of claim 9 wherein said displayed menu includes an menu key to identify the on-screen control objects and further comprising determining on-screen control objects to be recognized based on the menu key.

16. The method of claim 9 further receiving information from a remote device a list of on-screen control objects to be recognized.

17. An input device for generating position feedback for a graphical user interface, said remote control device comprising:
a camera for capturing at least a portion of an menu displayed on a display, said displayed menu containing one or more reference objects; and
a controller including an image processor to generate position feedback based on recognition of one or more reference objects in said displayed menu.

18. The input device of claim 17 wherein said position feedback comprises a position of a selected point in a captured image computed based on the relative position of the selected point to one or more reference objects.

19. A method of generating position feedback for a graphical user interface, said method comprising:
capturing at least a portion of an menu displayed on a display, said displayed menu containing one or more reference objects; and
generating position feedback based on recognition of one or more reference objects in said displayed menu.

20. The method of claim 19 wherein generating position feedback based on recognition of one or more reference objects in said displayed menu comprises computing a position of a selected point in said captured image based on the relative position of the selected point to one or more reference objects.
